(19) United States
(12) Patent Application Publication
(10) Pub. No.: US 2007/0238831 A1
(43) Pub. Date: Oct. 11, 2007

(54) Poly(arylene ether) composition and method of making the same

(76) Inventors: Steven Klei, Guilderland, NY (US); John B. Yates, Glenmont, NY (US)

Correspondence Address: CANTOR COLBURN, LLP, 55 GRIFFIN ROAD SOUTH, BLOOMFIELD, CT, 06002, US

(21) Appl. No.: 11/393,353

(22) Filed: Mar. 30, 2006

(51) Int. Cl. C08F 8/00

(52) U.S. Cl. 525/55

(57) ABSTRACT

A resin composition includes a poly(arylene ether) and a pH sensitive compound capable of providing a color change when the pH sensitive compound is at least partially extracted from the resin composition and is added to a basic or acidic solution.

### BACKGROUND OF THE INVENTION

This disclosure relates to poly(arylene ether) compositions, and more specifically to poly(arylene ether) compositions capable of being authenticated.

Poly(arylene ether) resins, such as polyphenylene ether (PPE) resins, are an extremely useful class of high performance engineering thermoplastics by reason of their hydrolytic stability, high dimensional stability, toughness, heat resistance, and dielectric properties. This unique combination of properties renders poly(arylene ether) based compositions suitable for a broad range of applications, which are well known in the art. For example, poly(arylene ether) blends are being widely used in the fields of automobile parts, electric parts, office devices, and the like.

With the commercial success of poly(arylene ether) resins, the practice of misrepresenting well-established and branded poly(arylene ether) resins is becoming common. Since many counterfeit, knock-off or imitation resins are sub-standard in quality compared to authentic resins, damage can be caused to the reputation of the well-established and branded materials, as well as to consumers that purchase these counterfeit materials. For example, as noted above, poly(arylene ether) blends are employed in automobile parts. As such, use of a sub-standard material can possibly result in physical harm or loss of human life as a result of failure of those automobile parts.

Accordingly, there is a need for poly(arylene ether) resins that can easily be authenticated.

### BRIEF DESCRIPTION OF THE INVENTION

The need discussed above has been satisfied by a resin composition comprising a poly(arylene ether); and a pH sensitive compound capable of providing a color change when the pH sensitive compound is at least partially extracted from the resin composition and is added to a basic or acidic solution.

Also disclosed is a method of making a resin composition. The method comprises melt mixing a poly(arylene ether) and a pH sensitive compound capable of providing a color change when the pH sensitive compound is at least partially extracted from the resin composition and is added to a basic or acidic solution.

Further disclosed is a method of authenticating a resin composition or an article. The method comprises at least partially extracting a pH sensitive compound from the resin composition or the article with a solvent, wherein the resin composition or the article comprises a poly(arylene ether) and the pH sensitive compound; mixing the solvent having the extracted pH sensitive compound with an acidic solution or a basic solution to form an observation mixture; and observing the observation mixture to determine if a predetermined color change occurred in the observation mixture.

### DETAILED DESCRIPTION OF THE INVENTION

In this specification and in the claims, which follow, reference will be made to a number of terms, which shall be defined to have the following meanings.

The singular forms “a,” “an,” and “the” include plural referents unless the context clearly dictates otherwise.

“Optional” or “optionally” means that the subsequently described event or circumstance may or may not occur, and that the description includes instances where the event occurs and instances where it does not.

“Combination” as used herein includes mixtures, copolymers, reaction products, blends, composites, and the like.

The terms “neutral”, “basic”, and “acidic” solutions are referred to throughout this disclosure. A neutral solution refers to a solution having a pH of 6 to 8, with a pH of 7 being completely neutral. A basic solution refers to a solution having a pH greater than 8. An acidic solution refers to a solution having a pH less than 6.

Furthermore, the endpoints of all ranges reciting the same characteristic are independently combinable and inclusive of the recited endpoint.

The modifier “about” used in connection with a quantity is inclusive of the stated value and has the meaning dictated by the context (e.g., it includes the degree of error associated with measurement of the particular quantity).

In one embodiment, a resin composition comprises A) a poly(arylene ether), and B) a pH sensitive compound capable of providing a color change when the pH sensitive compound is at least partially extracted from the resin composition and added to a basic or acidic solution. In one embodiment, the pH sensitive compound is stable at temperatures up to about 220° C., more specifically up to about 280° C., even more specifically up to about 320° C. The term “stable” is used through this disclosure to refer to a compound that has not undergone significant chemical changes to substantially impair the desired properties of the compound. For example, the pH sensitive compound remains capable of changing color when exposed to acidic or basic conditions even after being melt mixed with the poly(arylene ether) and extracted from the composition. Stability can further be verified by various techniques that are well know in the art, which include, but are not limited to, differential scanning calorimetry (DSC) and thermogravimetric analysis (TGA).

In one embodiment, which is discussed in greater detail below, the composition further comprises a poly(alkenyl aromatic).

In other embodiments, the composition comprises a polyamide. Polyamides, also known as nylons, are characterized by the presence of recurring amide groups (—C(O)NH—). Polyamide resins are well known in the art, as are methods for their preparation. They are widely commercially available. Blends of poly(arylene ether)s and polyamides are described, for example, in U.S. Pat. Nos. 4,732,938 to Grant et al., 4,859,739 to Yates et al., 4,873,276 to Fujii et al., 4,874,810 to Lee et al., 4,923,924 to Grant et al., 4,960,825 to van der Meer, 4,963,620 to Grant et al., 5,134,196 to van der Meer, 5,248,728 to Lee, 5,260,374 to Gallucci, 5,977,240 Marie Lohmeijer et al., 6,166,115 to Landa, 6,171,523 to Silvi et al., 6,469,093 and 6,486,255 to Koevoets et al., and in U.S. Patent Application Publication Nos. US 2005/0038191 A1 and US 2005/0038203 A1 of Elkovitch et al.

In yet other embodiments, the composition comprises a polyolefin. Suitable polyolefins include, for example, homopolymers and copolymers having at least about 80 weight percent of units derived from polymerization of ethylene, propylene, butylene, or a mixture thereof. Examples of polyolefin homopolymers include polyethylene, polypropylene, and polybutylene. Examples of polyolefin copolymers include random, graft, and block copolymers of ethylene, propylene, and butylene with each other, and further comprising up to 20 weight percent of units derived from C₅-C₁₀ alpha olefins (excluding aromatic alpha-olefins). Polyolefins further include blends of the above homopolymers and copolymers. Blends of poly(arylene ether)s and polyolefins are described, for example, in U.S. Pat. Nos. 6,495,630, 6,545,080, 6,627,701, 6,660,794, 6,815,491, 6,855,767, and 6,861,472 to Adedeji et al., and U.S. Patent Application Publication No. US 2005-0154130 A1 to Adedeji et al.

In various other embodiments, the composition can further comprise reinforcing fillers and secondary additives as discussed below.

As used herein, a “poly(arylene ether)” comprises a plurality of structural units of the formula (I): 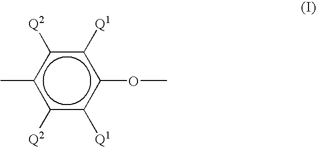
wherein for each structural unit, each Q¹ is independently halogen, primary or secondary C₁-C₁₂ alkyl, C₁-C₁₂ aminoalkyl, C₁-C₁₂ hydroxyalkyl, aryl, C₁-C₁₂ haloalkyl, C₁-C₁₂ hydrocarbyloxy, or C₁-C₁₂ halohydrocarbyloxy wherein at least two carbon atoms separate the halogen and oxygen atoms; and each Q² is independently hydrogen, halogen, primary or secondary C₁-C₁₂ alkyl, C₁-C₁₂ aminoalkyl, C₁-C₁₂ hydroxyalkyl, aryl, C₁-C₁₂ haloalkyl, C₁-C₁₂ hydrocarbyloxy, or C₁-C₁₂ halohydrocarbyloxy wherein at least two carbon atoms separate the halogen and oxygen atoms. In one embodiment, each Q¹ is independently C₁-C₄ alkyl or phenyl, and each Q² is independently hydrogen or methyl. The poly(arylene ether) can comprise molecules having aminoalkyl-containing end group(s), typically located in an ortho position to the hydroxy group. Also frequently present are diphenoquinone end groups, typically obtained from reaction mixtures in which diphenoquinone by-product is present.

The poly(arylene ether) can be in the form of a homopolymer, a copolymer, a graft copolymer, an ionomer, or a block copolymer, as well as combinations comprising at least one of the foregoing. For example, in one embodiment, the poly(arylene ether) comprises 2,6-dimethyl-1,4-phenylene ether units, optionally in combination with 2,3,6-trimethyl-1,4-phenylene ether units.

The poly(arylene ether) can be prepared by the oxidative coupling of monohydroxyaromatic compound(s) such as 2,6-xylenol and 2,3,6-trimethylphenol. Catalyst systems are generally employed for such coupling; they can contain heavy metal ion such as a copper, manganese, iron, or cobalt ions, usually in combination with various other materials such as secondary amines, tertiary amines, N,N′-dialkylalkylenediamines, halides, or combinations of two or more of the foregoing.

The poly(arylene ether) can be functionalized with a polyfunctional compound such as a polycarboxylic acid or those compounds having in the molecule both (a) a carbon-carbon double bond or a carbon-carbon triple bond and (b) at least one carboxylic acid, anhydride, amide, ester, imide, amino, epoxy, orthoester, or hydroxy group. Examples of such polyfunctional compounds include maleic acid, maleic anhydride, fumaric acid, and citric acid.

In one embodiment, the poly(arylene ether) comprises a capped poly(arylene ether). The terminal hydroxy groups may be capped with a capping agent via an acylation reaction, for example. The capping agent chosen is desirably one that results in a less reactive poly(arylene ether) thereby reducing or preventing crosslinking of the polymer chains and the formation of gels or black specks during processing at elevated temperatures. Suitable capping agents include, for example, esters of salicylic acid, anthranilic acid, or a substituted derivative thereof, and the like; esters of salicylic acid, and especially salicylic carbonate and linear polysalicylates, are preferred. As used herein, the term “ester of salicylic acid” includes compounds in which the carboxy group, the hydroxy group, or both have been esterified. Suitable salicylates include, for example, aryl salicylates such as phenyl salicylate, acetylsalicylic acid, salicylic carbonate, and polysalicylates, including both linear polysalicylates and cyclic compounds such as disalicylide and trisalicylide. The preferred capping agents are salicylic carbonate and the polysalicylates, especially linear polysalicylates. When capped, the poly(arylene ether) may be capped to any desirable extent up to 80 percent, more specifically up to about 90 percent, and even more specifically up to 100 percent of the hydroxy groups are capped. Suitable capped poly(arylene ether) and their preparation are described in U.S. Pat. Nos. 4,760,118 to White et al. and 6,306,978 to Braat et al.

Capping poly(arylene ether) with polysalicylate is also believed to reduce the amount of aminoalkyl terminated groups present in the poly(arylene ether) chain. The aminoalkyl groups are the result of oxidative coupling reactions that employ amines in the process to produce the poly(arylene ether). The aminoalkyl group, ortho to the terminal hydroxy group of the poly(arylene ether), can be susceptible to decomposition at high temperatures. The decomposition is believed to result in the regeneration of primary or secondary amine and the production of a quinone methide end group, which may in turn generate a 2,6-dialkyl-1-hydroxyphenyl end group. Capping of poly(arylene ether) containing aminoalkyl groups with polysalicylate is believed to remove such amino groups to result in a capped terminal hydroxy group of the polymer chain and the formation of 2-hydroxy-N,N-alkylbenzamine (salicylamide). The removal of the amino group and the capping provides a poly(arylene ether) that is more stable to high temperatures, thereby resulting in fewer degradative products, such as gels or black specks, during processing of the poly(arylene ether).

The poly(arylene ether) can have a number average molecular weight of about 3,000 grams per mole (g/mol) to about 40,000 g/mol and a weight average molecular weight of about 5,000 g/mol to about 80,000 g/mol, as determined by gel permeation chromatography using monodisperse polystyrene standards, a styrene divinyl benzene gel at 40° C. and samples having a concentration of 1 milligram per milliliter of chloroform. The poly(arylene ether) or combination of poly(arylene ether)s may have an initial intrinsic viscosity of about 0.08 deciliter per gram (dl/g) to about 0.50 deciliter per gram, as measured in chloroform at 25° C. Within this range, the initial intrinsic viscosity may be at least about 0.10 deciliter per gram, or at least about 0.30 deciliter per gram. Also within this range, the initial intrinsic viscosity may be up to about 0.46 deciliter per gram, or up to about 0.40 deciliter per gram. Initial intrinsic viscosity is defined as the intrinsic viscosity of the poly(arylene ether) prior to melt mixing with the other components of the composition, and final intrinsic viscosity is defined as the intrinsic viscosity of the poly(arylene ether) after melt mixing with the other components of the composition. As understood by one of ordinary skill in the art the viscosity of the poly(arylene ether) may be up to 30% higher after melt mixing. The percentage of increase can be calculated by 100×(final intrinsic viscosity−initial intrinsic viscosity)/initial intrinsic viscosity.

The poly(arylene ether) is generally used in amounts of 10 weight percent to 99.5 weight percent. Within this range, the poly(arylene ether) can be used in amounts greater than or equal to 20 weight percent, or, more specifically, greater than or equal to 30 weight percent. Also within this range, the poly(arylene ether) can be used in amounts of less than or equal to 90 weight percent, or, more specifically, less than or equal to 85 weight percent, or, even more specifically, less than or equal to 80 weight percent. Weight percent is with respect to the total weight of the composition.

The composition may, optionally, include a poly(alkenyl aromatic). The term “poly(alkenyl aromatic)” as used herein includes polymers prepared by methods known in the art including bulk, suspension, and emulsion polymerization, which contain at least 25% by weight of structural units derived from an alkenyl aromatic monomer of the formula 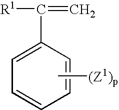
wherein R¹ is hydrogen, C₁-C₈ alkyl, or halogen; Z¹ is vinyl, halogen or C₁-C₈ alkyl; and p is 0, 1, 2, 3, 4, or 5. More specifically, alkenyl aromatic monomers include styrene, chlorostyrene, and vinyltoluene. The poly(alkenyl aromatic)s include homopolymers of an alkenyl aromatic monomer; random copolymers of an alkenyl aromatic monomer, such as styrene, with one or more different monomers such as acrylonitrile, butadiene, alpha-methylstyrene, ethylvinylbenzene, divinylbenzene and maleic anhydride; unhydrogenated and hydrogenated block copolymers of an alkenyl aromatic and a conjugated diene; and rubber-modified poly(alkenyl aromatic)s.

When the poly(alkenyl aromatic) is a unhydrogenated or hydrogenated block copolymers of an alkenyl aromatic and a conjugated diene, the conjugated diene may be, for example, 1,3-butadiene, 2-methyl-1,3-butadiene, 2,3-dimethyl-1,3-butadiene, or 1,3-pentadiene. The arrangement of the poly(alkenyl aromatic) and poly(conjugated diene) blocks may be a linear structure (e.g., diblock, triblock, tetrablock copolymers), or a radial teleblock structure with or without a branched chain. When the poly(alkenyl aromatic) is a hydrogenated block copolymer, the poly(conjugated diene) blocks may be partially or fully hydrogenated, so that about 10 to 100% of the unsaturated bonds in the aliphatic chain moiety derived from the conjugated diene are reduced. The poly(alkenyl aromatic) may be partially hydrogenated to selectively reduce pendant (rather than in-chain) aliphatic double bonds. Specific unhydrogenated block copolymers include styrene-butadiene diblock copolymers, styrene-butadiene-styrene triblock copolymers, styrene-isoprene diblock copolymers, and styrene-isoprene-styrene triblock copolymers. Specific hydrogenated block copolymers include styrene-(ethylene-butylene) diblock copolymers, styrene-(ethylene-butylene)-styrene triblock copolymers, styrene-(butadiene-butylene)-styrene triblock copolymers, and partially and fully hydrogenated styrene-isoprene-styrene triblock copolymers. Suitable unhydrogenated and hydrogenated block copolymers are further described in U.S. Pat. Nos. 6,855,767 and 6,872,777 to Adedeji et al.

When the poly(alkenyl aromatic) is a rubber-modified poly(alkenyl aromatic), it may comprise (a) a homopolymer of an alkenyl aromatic, and (b) a rubber modifier in the form of a blend with the homopolymer, or a graft on the homopolymer, or a combination thereof, wherein the rubber modifier can be a polymerization product of at least one C₄-C₁₀ non-aromatic diene monomer, such as butadiene or isoprene, and wherein the rubber-modified poly(alkenyl aromatic) comprises about 98 weight percent to about 70 weight percent of the homopolymer of an alkenyl aromatic monomer and about 2 weight percent to about 30 weight percent of the rubber modifier, specifically about 88 weight percent to about 94 weight percent of the homopolymer of an alkenyl aromatic monomer and about 6 weight percent to about 12 weight percent of the rubber modifier. These rubber-modified polystyrenes are commercially available as, for example, GEH 1897 from GE Plastics, and EB 6755 or MA5350 from Chevron Phillips Chemical Company.

In one embodiment, the poly(alkenyl aromatic) resin is selected from rubber-modified polystyrenes, atactic homopolystyrenes, syndiotactic polystyrenes, block copolymers of an alkenyl aromatic and a conjugated diene, hydrogenated block copolymers of an alkenyl aromatic and a conjugated diene, and combinations thereof. In one embodiment, the poly(alkenyl aromatic) comprises an atactic homopolystyrene having a weight average molecular weight of about 50,000 to about 1,500,000 atomic mass units. In one embodiment, the poly(alkenyl aromatic) comprises a rubber-modified polystyrene having a weight average molecular weight of about 50,000 to about 1,500,000 atomic mass units. In one embodiment, the poly(alkenyl aromatic) comprises a styrene-butadiene-styrene triblock copolymer having a butadiene content of about 60 weight percent to about 90 weight percent. In one embodiment, the poly(alkenyl aromatic) comprises a radial teleblock styrene-butadiene block copolymer.

The stereoregularity of the poly(alkenyl aromatic) can be atactic or syndiotactic. In one embodiment, the poly(alkenyl aromatic)s include atactic and syndiotactic homopolystyrenes. Suitable atactic homopolystyrenes are commercially available as, for example, EB3300 from Chevron Phillips Chemical Company, and 168M and 168MO from INEOS Styrenics. Suitable syndiotactic homopolystyrenes may be prepared according to methods described in U.S. Pat. Nos. 5,189,125 and 5,252,693 to Ishihara et al., 5,254,647 to Yamamoto et al., 5,272,229 to Tomotsu et al., and 5,294,685 to Watanabe et al.

When present, the poly(alkenyl aromatic) is generally used in an amount of about 10 weight percent to about 70 weight percent. Within this range, the poly(alkenyl aromatic) can be greater than or equal to about 20 weight percent, and more specifically greater than or equal to about 30 weight percent. Also within this range, the poly(alkenyl aromatic) is less than or equal to about 65 weight percent and more specifically less than or equal to about 60 weight percent. Weight percents are based on a total weight of the composition.

As briefly mentioned above, the pH sensitive compound is selected such that it is at least partially extractable from the composition and changes color upon addition to a basic solution or an acidic solution. In one embodiment, the pH sensitive compound is selected and is present in an amount such that if the composition itself were added to the same basic solution or acidic solution, no color change in the composition would be observed. In this embodiment, a color change is observed only after extracting the pH sensitive compound and adding the extracted pH sensitive compound to the basic solution or the acidic solution. In another embodiment, the pH sensitive compound is selected and is present in an amount such that if the composition itself were added to the same basic solution or acidic solution, a color change in the composition would be observed. In one embodiment, the pH sensitive compound significantly affects the color of the resin composition as produced. In this embodiment, the types and amounts of other colorants may be adjusted to produce a resin composition having the desired color characteristics.

The solvent that is used to extract the pH sensitive compound can be the same as or different from the basic solution or the acidic solution, as long as the pH sensitive compound is at least partially soluble in the solvent. In one embodiment, the solvent is a poor solvent for the poly(arylene ether). For this embodiment, suitable solvents include, for example, ketones having three to ten carbon atoms, such as acetone, methyl ethyl ketone, methyl isobutyl ketone, and the like, and mixtures thereof; ethers, such as 1,2-dimethoxyethane, tetrahydrofuran (THF), 1,4-dioxane, and the like, and mixtures thereof; nitrites, such as, acetonitrile and the like; and mixtures of the foregoing solvents. In another embodiment, the solvent is a good solvent for the poly(arylene ether). For this embodiment, suitable solvents include, for example, aromatic hydrocarbons such as benzene, toluene, xylenes, and the like; chlorinated aromatic hydrocarbons such as chlorobenzene, dichlorobenzenes, and the like; and chlorinated aliphatic hydrocarbons such as dichloromethane (methylene chloride), trichloromethane (chloroform), tetrachloromethane (carbon tetrachloride), dichloroethanes, trichloroethanes, and the like; and mixtures thereof.

The pH sensitive component can be selected to change color under basic conditions (e.g., phenolphthalein and thymolphthalein) or acidic conditions (e.g., bromothymol blue). While a variety of acids or bases can be added to the solvent to make a basic or acidic solution, in one embodiment, the acids or bases are selected to allow for ease in authentication such that special handling or testing equipment is not needed. Accordingly, pellets, molded articles, and the like that are manufactured using the composition can be readily authenticated at the manufacturing facility, warehouse, and the like.

Suitable bases include bases that yield a solution having a pH of greater than 8, more specifically a pH greater than 10. For example, suitable bases include, but are not limited to, sodium bicarbonate, borax, calcium carbonate, magnesia, ammonia, potassium carbonate, sodium carbonate, potassium hydroxide, sodium hydroxide, and lime, and combinations thereof. The basic solution is typically aqueous, although solutions in lower alcohols such as methanol and ethanol may also be used.

Suitable acids include acids that yield a solution having a pH less than 6, more specifically a pH less than or equal to 3. For example, suitable acids include, but are not limited to, acetic acid, citric acid, nitric acid, hydrochloric acid, sulfuric acid, tartaric acid, phosphoric acid, alum, and combinations thereof. The acidic solution is typically aqueous, although solutions in lower alcohols such as methanol and ethanol may also be used.

In one embodiment, the pH sensitive compound is present in amount that will not detrimentally affect the heat resistance, flow, and other mechanical properties of the composition so much as to render them unsuitable for their intended purpose. For example, the pH sensitive compound is generally used in an amount of about 0.01 weight percent to about 40 weight percent. Within this range, the pH sensitive compound can be greater than or equal to about 0.03 weight percent, or greater than or equal to 0.1 weight percent, or greater than or equal to about 0.15 weight percent. Also within this range, the pH sensitive compound is less than or equal to about 30 weight percent, or less than or equal to about 20 weight percent, or less than or equal to about 10 weight percent, or less than or equal to about 5 weight percent, or less than or equal to about 2 weight percent, or less than or equal to 1 weight percent, or less than or equal to about 0.75 weight percent, or less than or equal to about 0.5 weight percent. Weight percents are based on the total weight of the composition. Selection of the amount of pH sensitive compound may depend on variables including the identity of the pH sensitive compound, the types and amounts of other components in the composition, and whether the composition is meant to be blended with additional components before being used to form an article. For example, a higher concentration of the pH sensitive compound may be used when the composition is intended for use as a poly(arylene ether) concentrate that is blended with another resin before being used for article formation.

In one embodiment, the pH sensitive compound is selected to be colorless at a neutral pH or to be colorless as extruded. The lack of color of the pH sensitive compound allows the composition to be authenticated without affecting the color of the composition. Stated another way, the composition containing the pH sensitive compound adopts any color that a composition absent the pH sensitive compound would adopt. Since resin color can be a key part of a company's brand identification, the pH sensitive compound can advantageously be incorporated into the resin for authentication purposes without adversely affecting the color of the resin. In another embodiment, the pH of the compound itself can be adjusted such that the pH sensitive compound can be blended with a coloring package of the composition to obtain the desired color for the company's brand.

One embodiment is a method of authenticating a resin composition or an article, comprising: at least partially extracting a pH sensitive compound from the resin composition or the article with a solvent, wherein the resin composition or the article comprises a poly(arylene ether) and the pH sensitive compound; mixing the solvent having the extracted pH sensitive compound with an acidic solution or a basic solution to form an observation mixture; and observing the observation mixture to determine if a predetermined color change occurred in the observation mixture. For example a resin sample containing thymolphthalein and having an exposed surface area of at least about 20 square centimeters may be immersed in and agitated with 50 milliliters of acetone at 23° C. for 30 minutes. An aliquot (10 milliliters) of the acetone may then be removed using a pipet and added to a 20 milliliter vial atop a sheet of white paper and containing 5 milliliters of an aqueous sodium hydroxide solution of pH 10, as indicated using an EMD ColorPhast* pH strip. A color change in the solution from colorless to pink indicates the presence of the thymolphthalein. In particular, an increase (relative to pure solvent plus aqueous base) in absorbance of at least 0.05 absorbance units per centimeter path length at 592 nanometers (λₘₐₓ of the basic form of thymolphthalein) indicates the presence of the pH-sensitive compound and therefore the authenticity of the poly(arylene ether) contained in the composition.

One embodiment is a method of authenticating a resin composition or an article, comprising: at least partially extracting a pH sensitive compound from the resin composition or the article with a solvent, wherein the solvent is selected from the group consisting of acetone, tetrahydrofuran, methyl ethyl ketone, methyl isobutyl ketone, 1,2-dimethoxyethane, acetonitrile, 1,4-dioxane, and combinations thereof; and wherein the resin composition or the article comprises about 10 to about 90 weight percent of a poly(arylene ether) comprising 2,6-dimethyl-1,4-phenylene ether units; about 10 to about 70 weight percent of a poly(alkenyl aromatic) selected from the group consisting of homopolymers of an alkenyl aromatic monomer, random copolymers of an alkenyl aromatic monomer with one or more different monomers, unhydrogenated and hydrogenated block copolymers of an alkenyl aromatic and a conjugated diene; rubber-modified poly(alkenyl aromatic)s, and combinations thereof; and about 0.01 weight percent to about 1 weight percent of the pH sensitive compound; wherein the pH sensitive compound is capable of providing a color change when the pH sensitive compound is at least partially extracted from the resin composition and is added to a basic or acidic solution; wherein the pH sensitive compound is selected from the group consisting of thymolphthalein, phenolphthalein, methyl violet, thymol blue, methyl yellow, bromophenol blue, congo red, methyl orange, litmus, bromocresol purple, phenol red, thymol blue, alizarin Yellow R, Indigo carmine, and combinations thereof; mixing the solvent having the extracted pH sensitive compound with an acidic solution or a basic solution to form an observation mixture; and observing the observation mixture to determine if a predetermined color change occurred in the observation mixture.

In one embodiment, the pH sensitive compound changes color as a function of pH. That is, the intensity of the color can vary with the pH or the color itself can be different at different pH ranges. Multiple pH sensitive compounds can be employed that change color at different pH ranges. For example, an extract from a resin containing both bromothymol blue (e.g., changes yellow at pH 6.0 and below, and changes blue at pH 7.6 and above) and phenolphthalein (changes from colorless at pH 8.0 and below, and red at pH 10 and above) would be expected to change from yellow to blue to violet as the pH of the solution is changed from 6.0 to 10.0. In another embodiment, two different pH sensitive compounds are employed to achieve the same color, whose extracts are then differentiated upon introduction of an acid or base.

In one embodiment, the pH sensitive compound comprises thymolphthalein, phenolphthalein, or a combination thereof. Specific pH sensitive compounds, include, but are not limited to, methyl violet, thymol blue, methyl yellow, bromophenol blue, congo red, methyl orange, litmus, bromocresol purple, phenol red, thymol blue, alizarin Yellow R, Indigo carmine, and combinations thereof. Selection of a suitable pH sensitive compound may depend on several factors. If the authentication test is to be conducted on a molded article that must remain in service after the authentication test, then the pH sensitive compound should be selected so that exposure to solvent and basic or acidic solution will not significantly affect the required properties of the resin. For example, the excellent stability of poly(arylene ether)/poly(alkenyl aromatic) compositions to basic solutions makes phenolphthalein and thymolphthalein good choices since they change color in basic solution. If destructive testing is possible (e.g., on replaceable resin pellets), the pellets may be partially or fully dissolved in the solvent, and the pH sensitive compound may have a lower extinction coefficient in its visibly colored form, or it may be used at a reduced concentration in the resin. In order to avoid changes in the color of the composition as it is processed and articles containing it are molded, it may be preferable to choose a pH sensitive compound that changes color outside the pH range of about 6 to about 8, especially because trace impurities or additives in the composition may inadvertently trigger the color change. The thermal stability of the pH sensitive compound may also be considered. Thermal stability of candidate pH sensitive compounds may be determined by thermogravimetric analysis (TGA) or differential scanning calorimetry (DSC). For example, bromothymol blue exhibits a degradation temperature of 220° C. as measured by DSC, indicating that it is not a good choice for resin compositions that are compounded or molded at or above 220° C. Thymolphthalein and phenolphthalein were shown by DSC and TGA to undergo only melting at 255° C. and 265° C., respectively, and weight loss in TGA was only significant starting at about 280-290° C. These pH sensitive compounds are therefore suitable for use in relatively heat resistant resin compositions.

In various embodiments, the composition can also include effective amounts of at least one additive such as anti-oxidants, drip retardants, dyes, pigments, colorants, stabilizers, small particle mineral fillers such as clay, mica, and talc, visual effects additives, antistatic agents, plasticizers, lubricants, glass fibers (long, chopped or milled), carbon fibers, carbon fibrils (including single-wall nanotubes and multi-wall nanotubes) and combinations comprising at least one of the foregoing. In one embodiment, the composition comprises at least one additive chosen from magnesium oxide, zinc oxide, zinc sulfide, pentaerythritol beta-laurylthiopropionate, mineral oil, styrene-butadiene block copolymers, hydrogenated styrene-butadiene block copolymers, block copolymers of ethylene oxide and propylene oxide, polytetrafluoroethylene encapsulated in styrene-acrylonitrile copolymer (“TSAN”), terpene phenol resins, butylated triphenyl phosphate, resorcinol bis(diphenyl phosphate), tridecyl phosphite, tris(2,4-di-t-butylphenyl) phosphite, cis-13-docosenoic amide (erucamide), sodium alkyl sulfonates, polyethylene, clay, and glass fibers. These additives are known in the art, as are their effective levels and methods of incorporation. Effective amounts of the additives vary widely, but they can be present in a total amount up to about 60% or more by weight, of the total weight of the composition. In general, additives such as anti-oxidants, flame retardants, drip retardants, dyes, pigments, colorants, stabilizers, antistatic agents, plasticizers, lubricants, and the like are present in amounts of about 0.01 weight percent to about 5 weight percent of the total weight of the composition, while small particle mineral fillers and glass fibers comprise about 1 weight percent to about 60 weight percent of the total weight of the composition.

One embodiment is a resin composition comprising: about 10 to about 90 weight percent of a poly(arylene ether) comprising 2,6-dimethyl-1,4-phenylene ether units; about 10 to about 70 weight percent of a poly(alkenyl aromatic) selected from the group consisting of homopolymers of an alkenyl aromatic monomer, random copolymers of an alkenyl aromatic monomer with one or more different monomers, unhydrogenated and hydrogenated block copolymers of an alkenyl aromatic and a conjugated diene; rubber-modified poly(alkenyl aromatic)s, and combinations thereof; and about 0.01 weight percent to about 40 weight percent of a pH sensitive compound capable of providing a color change when the pH sensitive compound is at least partially extracted from the resin composition and is added to a basic or acidic solution; wherein the pH sensitive compound is selected from the group consisting of thymolphthalein, phenolphthalein, methyl violet, thymol blue, methyl yellow, bromophenol blue, congo red, methyl orange, litmus, bromocresol purple, phenol red, thymol blue, alizarin Yellow R, Indigo carmine, and combinations thereof; wherein all weight percents are based on the total weight of the composition.

One embodiment is a poly(arylene ether) concentrate, comprising: a poly(arylene ether), and about 0.5 to about 40 weight percent of a pH sensitive compound, based on the total weight of the concentrate. Within the range of about 0.5 to about 10 weight percent, the pH sensitive compound amount may be at least about 1 weight percent, or at least about 2 weight percent.

The concentrate may, optionally, further comprise a flame retardant. Suitable flame retardants include, for example, phenyl bisdodecyl phosphate, phenyl bisneopentyl phosphate, phenyl bis(3,5,5′-trimethylhexyl) phosphate, ethyl diphenyl phosphate, 2-ethylhexyl di(p-tolyl) phosphate, bis(2-ethylhexyl) p-tolyl phosphate, tritolyl phosphate, bis(2-ethylhexyl)phenyl phosphate, tri(nonylphenyl) phosphate, di(dodecyl) p-tolyl phosphate, tricresyl phosphate, triphenyl phosphate, dibutyl phenyl phosphate, 2-chloroethyl diphenyl phosphate, p-tolyl bis(2,5,5′-trimethylhexyl) phosphate, 2-ethylhexyl diphenyl phosphate, resorcinol bis(diphenyl phosphate), hydroquinone bis(diphenyl phosphate), bisphenol A bis(diphenyl phosphate), and the like, and combinations thereof. Other suitable flame retardants are described, for example, in U.S. Pat. No. 6,486,244 to Adedeji et al. When present, the flame retardant may be used in an amount of about 5 to about 50 weight percent, based on the total weight of the concentrate. Within this range, the flame retardant amount may be at least about 10 weight percent, or at least about 15 weight percent, or at least about 20 weight percent.

In one embodiment, the concentrate is provided in a particulate form that facilitates intimate blending with other resins. Thus, the poly(arylene ether) concentrate may be provided in a form such that at least 50 weight percent of the concentrate has particle size less than about 2.8 millimeters by about 2.8 millimeters and wherein less than 5% by weight of the concentrate has a particle size less than about 75 micrometers by about 75 micrometers. The weight fraction of particles having a particle size greater than about 2.8 millimeters by about 2.8 millimeters may be determined as the weight fraction retained on an ASTM E11 No. 7 sieve (having a mesh size of 2.8 millimeters). The weight fraction of particles having a particle size less than about 75 micrometers by about 75 micrometers may be determined as the weight fraction retained on an ASTM E11 No. 200 sieve (having a mesh size of 75 micrometers). Methods of preparing poly(arylene ether) compositions having such particle size characteristics are described, for example, in U.S. Pat. Nos. 6,096,821 and 6,258,879 to Adedeji et al.

The composition can be prepared by melt mixing or a combination of dry blending and melt mixing. Melt mixing can be performed in single- or twin-screw type extruders or similar mixing devices, which can apply a shear to the components. All of the components of the composition may be added initially to the processing system. In an embodiment in which the poly(arylene ether) is to be blended with an at least partially incompatible resin (e.g., polyamide or polyester), the poly(arylene ether) may be precompounded with a compatibilizing agent to form a functionalized poly(arylene ether). The functionalized poly(arylene ether) is then compounded with the other components. For example, the pH sensitive compound can be added at the same time as the poly(arylene ether) or added downstream of the poly(arylene ether). Advantageously, by adding the pH sensitive compound downstream, the pH sensitive compound is exposed to less heat history, which can cause the pH sensitive compound to degrade.

After the poly(arylene ether)-containing composition is formed, it is typically formed into strands, which are cut to form pellets. The strand diameter and the pellet length are typically chosen to prevent or reduce the production of fines (particles that have a volume less than or equal to 50% of the pellet) and for maximum efficiency in subsequent processing such as profile extrusion. An exemplary pellet length is about 1 millimeter (mm) to about 5 mm and an exemplary pellet diameter is about 1 mm to about 5 mm.

In one embodiment, a composition comprising a poly(arylene ether) is blended with a concentrate comprising a polymer resin and a pH sensitive compound. For example, in this embodiment, an article manufacturer could purchase poly(arylene ether) pellets, melt blend them with a concentrate comprising a polymer resin and a pH sensitive compound, and use the blend to produce poly(arylene ether)-containing articles that could subsequently be authenticated. In one embodiment, the polymer resin used to form the concentrate has a glass transition temperature or a melting temperature less than or equal to about 170° C., or less than or equal to about 165° C., or less than or equal to about 160° C., or less than or equal to about 155° C.

In one embodiment, the polymer resin used to form the concentrate is chosen from polystyrenes, hydrocarbon waxes, hydrocarbon resins, fatty acids, polyolefins, polyesters, fluoropolymers, epoxy resins, phenolic resins, rosins and rosin derivatives, terpene resins, acrylate resins, polyamides, and the like, and combinations thereof.

Suitable polystyrenes include homopolystyrenes having a weight average molecular weight of about 1,000 to about 300,000 atomic mass units. Within this range, the weight average molecular weight may be at least about 2,000 atomic mass units. Also within this range, the weight average molecular weight may be up to about 200,000 atomic mass units, or up to about 100,000 atomic mass units.

The term “hydrocarbon wax” is understood to mean a wax composed solely of carbon and of hydrogen. Suitable hydrocarbon waxes include, for example, microcrystalline waxes, polyethylene waxes, Fischer-Tropsch waxes, paraffin waxes, and combinations thereof.

Suitable hydrocarbon resins include aliphatic hydrocarbon resins, hydrogenated aliphatic hydrocarbon resins, aliphatic/aromatic hydrocarbon resins, hydrogenated aliphatic/aromatic hydrocarbon resins, cycloaliphatic hydrocarbon resins, hydrogenated cycloaliphatic resins, cycloaliphatic/aromatic hydrocarbon resins, hydrogenated cycloaliphatic/aromatic hydrocarbon resins, hydrogenated aromatic hydrocarbon resins, polyterpene resins, terpene-phenol resins, rosins and rosin esters, hydrogenated rosins and rosin esters, and mixtures of two or more thereof. As used herein, “hydrogenated”, when referring to the hydrocarbon resin, includes fully, substantially, and partially hydrogenated resins. Suitable aromatic resins include aromatic modified aliphatic resins, aromatic modified cycloaliphatic resins, and hydrogenated aromatic hydrocarbon resins having an aromatic content of about 1 to about 30%. Any of the above resins may be grafted with an unsaturated ester or anhydride using methods known in the art. Such grafting can provide enhanced properties to the resin. In one embodiment, the hydrocarbon resin in a hydrogenated aromatic hydrocarbon resin. Suitable hydrocarbon resins are commercially available and include, for example, EMPR resins, OPPERA® resins, and EMFR resins available from ExxonMobil Chemical Company; ARKON® and SUPER ESTER® rosin esters available from Arakawa Chemical Company of Japan; SYLVARES® polyterpene resins, styrenated terpene resins and terpene phenolic resins available from Arizona Chemical Company; SYLVATAC® and SYLVALITE® rosin esters available from Arizona Chemical Company; NORSOLENE® aliphatic aromatic resins available from Cray Valley; DERTOPHENE® terpene phenolic resins and DERCOLYTE® polyterpene resins available from DRT Chemical Company; EASTOTAC® resins, PICCOTAC® resins, REGALITE® and REGALREZ® hydrogenated cycloaliphatic/aromatic resins available from Eastman Chemical Company; WINGTACK® resins available from Goodyear Chemical Company; PICCOLYTE® and PERMALYN® polyterpene resins, rosins and rosin esters available from Eastman Chemical Company; coumerone/indene resins available from Neville Chemical Company; QUINTONE® acid modified C₅ resins, C₅/C₉ resins, and acid-modified C₅/C₉ resins available from Nippon Zeon; and CLEARON® hydrogenated terpene resins available from Yasuhara.

Suitable fatty acids include, for example, oleic acid, palmitic acid, stearic acid, isostearic acid, arachidic acid, behenic acid, cerotic acid, montanic acid, and combinations thereof.

Suitable polyolefins include, for example, polyethylenes, polypropylenes, ethylene-vinyl acetate copolymers, and combinations thereof. In one embodiment, the polyolefin is a low-density polyethylene having a weight-average molecular weight of about 5,000 to about 40,000 atomic mass units. Within this range, the weight average molecular weight may be up to about 30,000 atomic mass units, or up to about 20,000 atomic mass units. In one embodiment, the polymer resin comprises a homopolystyrene having a weight average molecular weight of about 1,000 to about 300,000 atomic mass units, and a low-density polyethylene having a weight average molecular weight of about 5,000 to about 40,000 atomic mass units.

Suitable polyesters include, for example, the condensation copolymerization products of dibasic acids (including anhydrides and acid esters) and aliphatic diols. Suitable dibasic acids include, for example, terephthalic acid, isophthalic acid, phthalic acid, naphthalene dicarboxylic acid, biphenylene dicarboxylic acid, tetrahydroterephthalic acid, tetrahydroisophthalic acid, tetrahydrophthalic acid, hydronaphthalene dicarboxylic acid, cyclohexanedicarboxylic acid, cyclopentyldicarboxylic acid, cyclooctyldicarboxylic acid, glutaric acid, sebacic, adipic acid, pimelic acid, malonic acid, fumaric acid, monoesters and diesters of the foregoing, and mixtures thereof. Suitable aliphatic diols include, for example, ethylene glycol, propylene glycol, butylene glycol, 1,3-propanediol, 1,3-butanediol, 1,4-butanediol, dipropylene glycol, 1,5-pentanediol, 1,6-hexanediol, diethylene glycol, 1,4-cyclohexanediol, 1,4-cyclohexanedimethanol, neopentyl glycol, 1,8-octanediol, 1,10-decanediol, 1,12-dodecanediol, diethylene glycol, triethylene glycol, tetraethylene glycol, and combinations thereof.

Suitable fluoropolymers include, for example, polytetrafluoroethylene, ethylene-tetrafluoroethylene copolymers, polyvinyidene fluoride, and combinations thereof.

Suitable epoxy resins include, for example, bisphenol A diglycidyl ether, bisphenol F diglycidyl ether, epoxy novolacs, vinyl cyclohexane dioxide, oligomers of the foregoing epoxy resins, and combinations thereof. Suitable epoxy resins are commercially available as, for example, EPON® 828, EPON® 825, D.E.R. 317, EPON® 1001F, ERL4221, and EPON® 871, all from Dow Chemical; and ARALDITE® GT7071 from Ciba Specialty Chemicals.

Suitable phenolic resins include, for example, novolac resins, resol resins, phenol-formaldehyde resins, novolacs, phenol-acetaldehyde resins, resorcinol-formaldehyde resins, phenol-furfural resins, polyvinyl phenol polymers, and combinations thereof.

Suitable rosin and rosin derivatives include, for example, tall oil rosins, gum rosins, wood rosins, hydrogenated rosins, rosin esters, and combinations thereof.

Suitable terpene resins include, for example, polymers of beta-pinene, polymers of alpha-pinene, polymers of d-limonene, terpene-phenol resins, aromatic-modified terpene resins, and combinations thereof.

Suitable acrylate resins include, for example, homopolymers and copolymers of alkyl (meth)acrylate monomers such as methyl acrylate, methyl methacrylate, ethyl acrylate, ethyl methacrylate, and the like.

Suitable polyamides belong to a generic family of resins known as nylons, characterized by the presence of an amide group (—C(O)NH—). Nylon-6 and nylon-6,6 are the generally preferred polyamides and are available from a variety of commercial sources. Other polyamides, however, such as nylon-4,6, nylon-12, nylon-6,10, nylon 6,9, nylon 6/6T and nylon 6,6/6T with triamine contents below about 0.5 weight percent, as well as others, such as the amorphous nylons, may be useful for particular applications. Mixtures of various polyamides, as well as various polyamide copolymers, are also useful. Polyamides can be obtained by a number of well known processes such as those described in U.S. Pat. Nos. 2,071,250, 2,071,251, 2,130,523, and 2,130,948 to Carothers; 2,241,322 and 2,312,966 to Hanford; and 2,512,606 to Bolton et al. Nylon-6, for example, is a polymerization product of caprolactam. Nylon-6,6 is a condensation product of adipic acid and 1,6-diaminohexane. Likewise, nylon 4,6 is a condensation product between adipic acid and 1,4-diaminobutane. Besides adipic acid, other useful diacids for the preparation of nylons include azelaic acid, sebacic acid, dodecane diacid, as well as terephthalic and isophthalic acids, and the like. Other useful diamines include m-xylyene diamine, di-(4-aminophenyl)methane, di-(4-aminocyclohexyl)methane; 2,2-di-(4-aminophenyl)propane, 2,2-di-(4-aminocyclohexyl)propane, among others. Copolymers of caprolactam with diacids and diamines are also useful.

After a composition comprising a poly(arylene ether) and a pH sensitive compound is formed, it may be converted to articles using thermoplastic processes including, for example, injection molding, blow molding, extrusion, sheet extrusion, film extrusion, profile extrusion, pultrusion, compression molding, thermoforming, pressure forming, hydroforming, vacuum forming, foam molding, and the like.

Exemplary articles include all or portions of the following articles: electrical components, fluid engineering components, automotive exterior parts, automotive underhood parts, consumer electronics, televisions, flexible industrial parts, wire coatings, materials for electronics fabrication, autoclavable articles for healthcare, and low-smoke materials for building and construction.

It is briefly noted that articles made using the composition can be authenticated. Stated another way, embodiments are envisioned where the pH sensitive article is employed to authenticate an article rather than the raw materials used to make the article. In this embodiment, the pH sensitive compound may be added during formation of the composition or formation of the article. There may be an advantage to adding the pH sensitive compound during formation of the article, because temperatures employed in forming articles, e.g., molding temperatures, are typically less than those employed in melt blending used to form pellets, as discussed above. As such, adding the pH sensitive compound during formation of the article can minimize degradation of the pH sensitive compound.

In one embodiment, an article may be surface coated with a pH sensitive compound to allow subsequent authentication of the article. Thus, one embodiment is a method of authenticating an article, comprising: at least partially extracting a pH sensitive compound from the surface of an article with a solvent, wherein the article is the product of solvent coating with a pH sensitive compound a surface of an article comprising a poly(arylene ether); mixing the solvent having the extracted pH sensitive compound with an acidic solution or a basic solution to form an observation mixture; and observing the observation mixture to determine if a predetermined color change occurred in the observation mixture. Solvent coating with a pH sensitive compound may comprise applying to a surface of the article a solution comprising the pH sensitive compound and a solvent and removing solvent from the surface of the article. Suitable solvents for solvent coating include those solvents described above in the context of extracting a pH sensitive compound from an article. In addition, suitable solvents for solvent coatings comprise C₁-C₆ alkanols such as, for example, methanol, ethanol, n-propanol, isopropanol, and the like.

The following non-limiting examples further illustrate the various embodiments described herein.

### EXAMPLE 1

This working example employed the materials listed in Table 1. The amounts employed in the Examples are in weight percent based on the total weight of the composition, unless otherwise stated.

TABLE 1

| Material | Description/Supplier |
|---|---|
| PPE | Poly(2,6-dimethyl-1,4-phenylene ether) |
| | having an intrinsic viscosity of 0.46 dl/g |
| | as determined in chloroform at 25° C., |
| | which is commercially available from |
| | GE Plastics. |
| HIPS | FX510 from Nova Chemicals |
| Polyethylene | Novapol GM-2024-A from Nova |
| | Chemicals |
| Zinc oxide | CR-4 from GH Chemicals |
| Zinc Sulfide | Sachtolith HD ZNS from Sachtleben |
| | Corp. |
| Tridecylphosphite | TDP Weston from Crompton Corp. |
| Polycarbonate/pentaerythritol | LEXAN 121R resin from GE Plastics |
| tetrastearate (PETS) blend | |

A base powder blend was prepared comprising 48.6 parts by weight (pbw) 0.46 IV PPE, 48.6 pbw rubber-modified polystyrene (also known as high-impact polystyrene or HIPS), 1.45 pbw polyethylene, 0.145 pbw zinc oxide, 0.145 pbw zinc sulfide, and 0.972 pbw tridecylphosphite. All components were dry blended and shaken for 3 minutes in a paint shaker prior to extrusion. The resulting dry blend was added to the feed throat of the extruder, extruded at 290° C., and cut into pellets. The extruder was a 24-millimeter, 8-barrel, twin-screw, co-rotating Prism extruder having a 28:1 length-to-diameter (L/D) ratio. Plastic color chips of 2 inches×3 inches×0.100 inch (5.08 centimeters×7.62 centimeters×0.254 centimeter) dimensions were molded from the pellets at 300° C., with a molding tool temperature of 88° C.

The Example 1 powder blend comprised an additional 0.1 part by weight thymolphthalein, which was added at the dry blending stage. The molded plaques were light tan and opaque in color, indicative of natural resin. A plastic color chip was placed in a glass jar having a 2 inch (5.08 centimeter) inner diameter, containing about 50 milliliters (mL) acetone. The jar was capped, and the mixture was allowed to stand for 30 minutes. The jar was agitated initially for 5 seconds, again for 5 seconds at 15 minutes, and again for five seconds at 30 minutes. An aliquot (10 mL) of the acetone was then removed using a pipet and added to a 20 mL glass vial that was atop a sheet of white paper and that contained 5 mL of a NaOH/water solution of pH 10, as measured using a pH strip. A color change from colorless to light blue was observed. The plaque was removed from the extraction/developing chamber and allowed to air dry. It looked substantially identical to an unexposed chip in color, although the 60 degree gloss value of the polished chip side was reduced from 90 to 25. The 60 degree gloss value was measured according to ASTM D523 using a BYK-Gardner micro-TRI-gloss meter.

### EXAMPLE 2

In this example, the powder blend comprised 0.03 part by weight thymolphthalein. The same procedure for Example 1 was employed. A color change was not detectable by visual observation. The plaque was removed from the extraction/developing chamber and allowed to air dry. Again, the chip looked substantially the same as the unexposed chip in color, although the 60 degree gloss value of the polished chip side was similarly reduced as described in Example 1.

### EXAMPLE 3

In this example, the powder blend comprised 0.1 part by weight phenolphthalein. The same procedure for Example 1 was employed. A color change from colorless to pink was visually observed. The plaque was removed from the extraction/developing chamber and allowed to air dry. It looked substantially identical to an unexposed chip in color, although the 60 degree gloss value of the polished chip side was similarly reduced as described in Example 1.

### EXAMPLE 4

The powder blend comprised 0.03 part by weight phenolphthalein. The same procedure for Example 1 was employed. A color change was not detectable by visual observation. The plaque was removed from the extraction/developing chamber and allowed to air dry. It looked substantially identical to an unexposed chip in color, although the 60 degree gloss value of the polished chip side was similarly reduced as described in Example 1.

### EXAMPLES 5-8

In these examples, the powder blends respectively comprised 0.03 part by weight (Ex. 5), 0.1 part by weight (Ex. 6), 0.5 part by weight (Ex. 7), and 1.0 part by weight (Ex. 8) thymolphthalein. The same procedure was followed as for Example 1 with the exception that the solvent was changed from acetone to tetrahydrofuran (THF). A color change was visually observed in each of examples 5-8, which indicated that varying the solvent can lead to a wider range in using the pH sensitive compound. For example, when acetone was used in Example 2, the color change was not clearly observed, whereas a color change was clearly observed using tetrahydrofuran solvent in Example 5.

Advantageously, the composition comprising the pH sensitive compound is capable of being authenticated without the use of spectroscopy or other expensive equipment. Moreover, since the pH sensitive compound can be disposed in the composition or article in such a manner that a person observing the composition could not observe a physical difference in appearance of a composition with the pH sensitive compound from one without the pH sensitive compound, a covert method of authenticating the composition is obtained. Additionally, since the color sensitive material is present in an amount less than or equal to about 1 weight percent of the total composition, minimal loss of mechanical properties is observed in the composition. Moreover, as readily understood by those skilled in the art, any loss in the mechanical properties or melt flow properties can be overcome by adjusting, for example, the ratio of poly(arylene ether) to the poly(alkenyl aromatic).

### EXAMPLE 9

This example describes the preparation of a concentrate of a pH sensitive compound in a poly(arylene ether)-compatible resin. The concentrate was prepared by melt kneading 5 weight percent phenolphthalein in rubber-modified polystyrene obtained as GEH HIPS from GE Plastics. Melt kneading was conducted on a 24-millimeter, co-rotating twin-screw PRISM extruder operating at 232° C. (450° F.). The extrudate was cooled and pelletized.

### EXAMPLE 10

This example illustrates the use of a concentrate of pH sensitive compound in a poly(arylene ether)-compatible resin to authenticate a poly(arylene ether) composition. A melt-kneaded blend was prepared using 60 grams of the 5 weight percent phenolphthalein concentrate pellets from Example 9 and 1800 grams of a black-colored, flame-retarded blend of poly(2,6-dimethyl-1,4-phenylene ether), rubber-modified polystyrene, and additives obtained as NORYL® SE1-701 from GE Plastics. The melt-kneading procedure of Example 9 was employed, and the resulting pellets were used to injection mold chips having dimensions 2 inches×3 inches×0.118 inch (5.08 centimeters×7.62 centimeters×0.300 centimeter). A piece measuring 2 inches×0.5 inches×0.118 inch (5.08 centimeters×1.27 centimeters×0.300 centimeter) was cut from the chip and added to a 20 milliliter scintillation vial. To this vial was added 7 milliliters tetrahydrofuran solvent. The vial was then capped, agitated by shaking for 5 seconds, and allowed to sit for 30 minutes at room temperature. A 2 milliliter tetrahydrofuran solution aliquot was then removed from the vial using a pipet and added to a clean 20 milliliter vial. To this test vial was then added 2 milliliters of a pH 10 aqueous NaOH solution. A white precipitate was observed, but there was no color change. The remaining 5 milliliters tetrahydrofuran solution and the test piece were allowed to sit in the capped vial for 18 hours. A 2 milliliter aliquot was then removed and added to a clean 20 milliliter vial. To this test vial was then added 2 milliliters of the NaOH solution. A white precipitate was observed, and the slurry turned pink. With agitation of the vial, the pink color faded to white. An additional 2 milliliters of the NaOH solution was added, and the pink color returned. The pink color was maintained even after agitation of the vial. This experiment shows that a poly(arylene ether) resin composition may be made authenticatable just prior to molding by adding a small amount of a concentrate of a pH sensitive compound in a poly(arylene ether)-compatible resin.

### EXAMPLE 11

This example shows that a poly(arylene ether) resin composition may be made authenticatable by direct addition of a pH sensitive compound (i.e., without first incorporating the pH sensitive compound into a resin concentrate). A melt-kneaded blend was prepared using 3 grams of phenolphthalein powder and 1800 grams NORYL® SE1-701. The pelletized blend was used to injection mold chips having dimensions 2 inches×3 inches×0.118 inch (5.08 centimeters×7.62 centimeters×0.300 centimeter). A piece measuring 2 inches×0.5 inches×0.118 inch (5.08 centimeters×1.27 centimeters×0.300 centimeter) was cut from the chip and added to a 20 milliliter scintillation vial. To this vial was added 7 milliliters tetrahydrofuran solvent. The vial was then capped, agitated by shaking for 5 seconds, and allowed to sit for 30 minutes at room temperature. A 2 milliliter tetrahydrofuran solution aliquot was then removed using a pipet and added to a clean 20 milliliter vial. To this test vial was then added 2 milliliters pH 10 NaOH solution. A white precipitate was observed, but there was no color change. The remaining 5 milliliters tetrahydrofuran solution and the test piece were allowed to sit in the capped vial for 18 hours. A 2 milliliter aliquot was then removed and added to a clean 20 milliliter vial. To this test vial was then added 2 milliliters of NaOH solution. A white precipitate was observed, and the slurry turned pink. With agitation of the vial, the pink color faded to white. An additional 2 milliliters NaOH solution was added, and the pink color returned. The pink color was maintained even after agitation of the vial. This experiment shows that a poly(arylene ether) resin composition may be made authenticatable by adding a small amount of pH sensitive compound. Together with Example 10, it also shows that similar authentication results are obtained when a pH sensitive compound is incorporated in a poly(arylene ether) composition directly or via a resin concentrate.

### EXAMPLE 12

The procedure of Example 10 was used, except that the concentrate was blended not with NORYL® SE1-701 but with NORYL® N190X-701, which is an organophosphate flame-retarded blend of poly(2,6-dimethyl-1,4-phenylene ether), rubber-modified polystyrene, rubber impact modifier, and additives. Similar authentication results were obtained, in that a color change was observed on mixing pH 10 aqueous NaOH solution with a tetrahydrofuran solution that had contacted the molded composition for 18 hours, but not with a tetrahydrofuran solution that had contacted the molded composition for only 30 minutes.

### EXAMPLE 13

This procedure of Example 11 was used, except that the pH sensitive compound was blended directly not with NORYL® SE1-701 but with NORYL® N190X-701. Similar authentication results were obtained, in that a color change was observed on mixing a pH 10 aqueous NaOH solution with a tetrahydrofuran solution that had contacted the molded composition for 18 hours, but not with a tetrahydrofuran solution that had contacted the molded composition for only 30 minutes.

### EXAMPLES 14-17

These examples illustrate that a molded article may be made authenticatable by application of a surface coating of a pH sensitive compound. Chips having dimensions 2 inches×3 inches×0.100 inch (5.08 centimeters×7.62 centimeters×0.254 centimeter) were molded from two colored blends of poly(2,6-dimethyl-1,4-phenylene ether) and rubber-modified polystyrene: blend 1, in which the color is derived from a pigment, and blend 2, in which the color is derived from dyes. Two solutions of 5.2 weight percent phenolphthalein in solvent were prepared: one in acetone and one in ethanol.

The molded chips were coated with pH indicator as follows. A chip was placed on a flat surface, and two milliliters of the ethanol or acetone solution of pH indicator was added drop-wise to the face of the chip until it was completely covered with solution. The chips were then dried (i.e., solvent was driven off) by blowing a stream of nitrogen gas over the solution-coated chip. The chips coated with acetone solution remained tacky even when dried for several minutes, whereas the chips coated with ethanol solution dried rapidly and were not tacky. The combinations of resin type and coating solvent are summarized in Table 2.

From each coated chip, a section having dimensions 3 inches×0.5 inch×0.100 inch (7.62 centimeters×1.27 centimeters×0.254 centimeter) was cut out and placed in a 20 milliliter glass vial with 5 milliliters of acetone, and agitated for 5 seconds. After 2 minutes, a 2 milliliter aliquot of each acetone solution was added to a corresponding empty vial. The aliquots corresponding to Examples 15 and 17 had a noticeably grey color. To each vial was added 1-2 milliliters of an aqueous pH 10 NaOH solution. Each solution turned a deep pink, although the samples for Examples 15 and 17 were darker, presumably due to the combined absorbances of the pH indicator and extracted colorants.

These examples show that molded articles may be authenticated by first solvent coating them with a pH sensitive compound and subsequently extracting the pH sensitive compound from the surface of the article. Ethanol is a particularly useful solvent for the solvent coating process. The examples also show that the authentication method may be used even when the resin composition contains extractable colorants.

TABLE 2

| | Ex. 14 | Ex. 15 | Ex. 16 | Ex. 17 |
|---|---|---|---|---|
| Resin composition | blend 1 | blend 2 | blend 1 | blend 2 |
| Coating solvent | acetone | acetone | ethanol | ethanol |

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

1. A resin composition comprising:
a poly(arylene ether); and
a pH sensitive compound capable of providing a color change when the pH sensitive compound is at least partially extracted from the resin composition and is added to a basic or acidic solution.

2. The resin composition of claim 1, wherein the poly(arylene ether) comprises a plurality of structural units of the formula 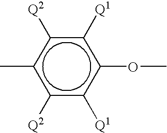
wherein for each structural unit, each Q¹ is independently halogen, primary or secondary C₁-C₁₂ alkyl, C₁-C₁₂ aminoalkyl, C₁-C₁₂ hydroxyalkyl, aryl, C₁-C₁₂ haloalkyl, C₁-C₁₂ hydrocarbyloxy, or C₁-C₁₂ halohydrocarbyloxy wherein at least two carbon atoms separate the halogen and oxygen atoms; and each Q² is independently hydrogen, halogen, primary or secondary C₁-C₁₂ alkyl, C₁-C₁₂ aminoalkyl, C₁-C₁₂ hydroxyalkyl, aryl, C₁-C₁₂ haloalkyl, C₁-C₁₂ hydrocarbyloxy, or C₁-C₁₂ halohydrocarbyloxy wherein at least two carbon atoms separate the halogen and oxygen atoms.

3. The resin composition of claim 1, wherein the poly(arylene ether) comprises 2,6-dimethyl-1,4-phenylene ether units.

4. The resin composition of claim 1, wherein the pH sensitive compound is stable at temperatures up to about 280° C.

5. The resin composition of claim 1, further comprising a poly(alkenyl aromatic).

6. The resin composition of claim 1, further comprising a polyamide or a polyolefin.

7. The resin composition of claim 1, wherein the pH sensitive compound is present in an amount of about 0.01 weight percent to about 40 weight percent based on a total weight of the composition.

8. The resin composition of claim 7, wherein the amount of pH sensitive compound is about 0.1 weight percent to about 1 weight percent.

9. The resin composition of claim 1, wherein the pH sensitive compound comprises thymolphthalein, phenolphthalein, or a combination thereof.

10. The resin composition of claim 1, wherein the pH sensitive compound is selected from the group consisting of methyl violet, thymol blue, methyl yellow, bromophenol blue, congo red, methyl orange, litmus, bromocresol purple, phenol red, thymol blue, alizarin Yellow R, Indigo carmine, and combinations thereof.

11. The resin composition of claim 1, further comprising a second pH sensitive compound.

12. The resin composition of claim 1, wherein the pH sensitive compound is colorless at a neutral pH.

13. The resin composition of claim 1, wherein the pH sensitive compound is capable of changing to multiple colors as a function of pH.

14. An article comprising the composition of claim 1.

15. A resin composition comprising:
about 10 to about 90 weight percent of a poly(arylene ether) comprising 2,6-dimethyl-1,4-phenylene ether units;
about 10 to about 70 weight percent of a poly(alkenyl aromatic) selected from the group consisting of homopolymers of an alkenyl aromatic monomer, random copolymers of an alkenyl aromatic monomer with one or more different monomers, unhydrogenated and hydrogenated block copolymers of an alkenyl aromatic and a conjugated diene; rubber-modified poly(alkenyl aromatic)s, and combinations thereof; and
about 0.01 weight percent to about 40 weight percent of a pH sensitive compound capable of providing a color change when the pH sensitive compound is at least partially extracted from the resin composition and is added to a basic or acidic solution; wherein the pH sensitive compound is selected from the group consisting of thymolphthalein, phenolphthalein, methyl violet, thymol blue, methyl yellow, bromophenol blue, congo red, methyl orange, litmus, bromocresol purple, phenol red, thymol blue, alizarin Yellow R, Indigo carmine, and combinations thereof;
wherein all weight percents are based on the total weight of the composition.

16. A poly(arylene ether) concentrate, comprising:
a poly(arylene ether), and
about 0.5 to about 40 weight percent of a pH sensitive compound, based on the total weight of the concentrate.

17. The poly(arylene ether) concentrate of claim 16, further comprising about 5 to about 5 weight percent of an organic phosphate flame retardant.

18. A method of making a resin composition, comprising:
melt mixing a poly(arylene ether) and a pH sensitive compound capable of providing a color change when the pH sensitive compound is at least partially extracted from the resin composition and is added to a basic or acidic solution.

19. The method of claim 18, further comprising melt mixing a poly(alkenyl aromatic) with the poly(arylene ether) and the pH sensitive compound.

20. The method of claim 19, wherein the poly(arylene ether) and the poly(alkenyl aromatic) are melt mixed to form a first melt blend, and the pH sensitive is added to the first melt blend to form a second melt blend.
